(19) United States
(12) Patent Application Publication
(10) Pub. No.: US 2009/0274036 A1
(43) Pub. Date: Nov. 5, 2009

(54) HARQ BASED ICI CODING SCHEME

(75) Inventors: Hsin-Piao LIN, Taoyuan City (TW); Rong Terng JUANG, Erlin Township (TW); Pang-An TING, Fongyuan City (TW); Chien Yu KAO, Sanchong City (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Industrial Technology Research Institute

(21) Appl. No.: 12/247,708

(22) Filed: Oct. 8, 2008

Related U.S. Application Data
(60) Provisional application No. 61/050,415, filed on May 5, 2008.
(60) Provisional application No. 61/050,694, filed on May 6, 2008.

(51) Int. Cl. H04J 11/00

(52) U.S. Cl. 370/208

(57) ABSTRACT

Method and apparatus for transmitting data in an OFDM communication system, the method including transmitting over a channel, an original data packet that includes original data, the original data packet including at least one modulated data symbol encoded onto at least one sub-carrier using a first coding scheme. The method further includes transmitting a retransmitted data packet corresponding to the original data packet in response to a non-acknowledgement (NACK), the retransmitted data packet including a copy of the original data packet wherein the at least one modulated data symbol is encoded onto the at least one sub-carrier using a second coding scheme.

### RELATED APPLICATIONS

This application claims the benefit of U.S. Provisional Application No. 61/050,415, filed May 5, 2008, and U.S. Provisional Application No. 61/050,694, filed May 6, 2008. The contents of all above applications are incorporated in their entirety herein by reference.

### TECHNICAL FIELD

This invention relates to orthogonal frequency division multiplexing (OFDM) communication systems and, more specifically, to the reduction of inter carrier interference (ICI) in an OFDM system.

### DISCUSSION OF RELATED ART

Since the inception of modern communication theory, most communication systems have taken a single-carrier approach, where all information to be transmitted is modulated by a single carrier.

More recently, however, with increasing demand for faster, secure and more reliable communication systems, multi-carrier systems are an alternative approach.

In a multi-carrier system, available bandwidth is split into several sub-channels and instead of transmitting information all at once, data is transmitted more slowly, in parallel, over these sub-channels. This enables the data symbols to have a longer duration while still maintaining relatively high overall data rates.

OFDM is a modulation method for communication using multiple carriers spaced uniformly in the frequency domain. In OFDM, data is encoded to multiple orthogonal sub-carriers, and sent simultaneously. Since OFDM allows adjacent carrier frequencies to be very closely spaced, more closely than in some other multi-carrier systems, OFDM systems can use the available bandwidth more efficiently. In addition, OFDM mitigates the effects of frequency-selective channel fading by dividing a high-rate serial data stream into several parallel low-rate data streams, the terms “high” and “low” being used herein in a relative sense only.

A set of orthogonal sub-carriers together form an OFDM symbol. To avoid the inter-symbol interference (ISI), successive OFDM symbols are separated by a guard interval. A cyclic-prefix (CP) is used as a guard interval which is inserted before each transmitted block of data to prevent ISI. By selecting the length of the guard interval to be larger than the maximum channel delay, the effects of ISI can be completely eliminated.

Since OFDM allows adjacent carrier frequencies to be very closely spaced, OFDM systems may be sensitive to the orthogonality of the sub-carriers. The orthogonality among the sub-carriers may be lost due to oscillator frequency offset or Doppler spread. The loss of orthogonality among the sub-carriers results in ICI which degrades the performance of OFDM systems.

Therefore, for more efficient and reliable data transmission in multi-carrier systems, there is a need to mitigate the effects of ICI while maintaining a relatively high overall data rate.

### SUMMARY

Consistent with some embodiments of the present invention, a method for transmitting data in an OFDM communication system, includes transmitting over a channel, an original data packet that includes original data, the original data packet including at least one modulated data symbol encoded onto at least one sub-carrier using a first coding scheme. The method further includes transmitting a retransmitted data packet corresponding to the original data packet in response to a non-acknowledgement (NACK), the retransmitted data packet including a copy of the original data packet wherein the at least one modulated data symbol is encoded onto the at least one sub-carrier using a second coding scheme.

A transmitter in an OFDM communication system includes an inter-carrier interference (ICI) canceling unit coupled to receive at least one modulated data symbol and utilizing at least one processing device to encode the at least one modulated data symbol onto at least one sub-carrier by implementing a coding scheme.

A method for receiving data in an OFDM communication system includes receiving over a channel an original data packet that includes original data, the original data packet including at least one modulated data symbol encoded onto at least one sub-carrier; sending an Acknowledgement (ACK) if no error is detected in the original data packet or sending a non-acknowledgement (NACK) if an error is detected in the original data packet, and storing the original data packet; receiving in response to the NACK a retransmitted data packet corresponding to the original data packet, and storing the retransmitted data packet; combining the original data packet and the retransmitted data packet, and decoding the combination to obtain the original data.

A receiver in an OFDM communication system includes a windowing and combining (WAC) unit coupled to receive a plurality of time domain OFDM symbols corresponding to a plurality of modulated data symbols encoded onto a respective plurality of sub-carriers, each of the time domain OFDM symbols includes a cyclic prefix (CP) and a data portion. The receiver further includes a memory; a maximum ratio combining (MRC) unit coupled to receive a plurality of transmissions of packet data, the MRC unit configured to store each of the plurality of modulated data symbols in the memory and to combine the received plurality of transmissions of packet data; and a decoder and de-mapping (DD) unit DD coupled to receive the combination of the plurality of transmissions of packet data and to decode the combination.

Additional features and advantages of the invention will be set forth in part in the description which follows, and in part will be obvious from the description, or may be learned by practice of the invention. The features and advantages of the invention will be realized and attained by means of the elements and combinations particularly pointed out in the appended claims.

The accompanying drawings, which are incorporated in and constitute a part of this specification, illustrate embodiments of the invention and, together with the description, serve to explain the principles of the invention.

### BRIEF DESCRIPTION OF THE DRAWINGS

FIG. 1 illustrates a functional block diagram of an OFDM system consistent with some embodiments of the present invention.

FIG. 2 illustrates a method for ICI cancellation consistent with some embodiments of the present invention.

FIGS. 3a and 3b are flow diagrams of a HARQ based OFDM method consistent with some embodiments of the present invention.

FIGS. 4a and 4b are graphs illustrating performance of an OFDM system consistent with some embodiments of the present invention.

### DETAILED DESCRIPTION

In the following description and claims, the terms “coupled” and “connected,” along with their derivatives, may be used. It should be understood that these terms are not intended as synonyms for each other. Rather, in particular embodiments, “connected” and/or “coupled” may be used to indicate that two or more elements are in direct physical or electronic contact with each other. However, “coupled” may also mean that two or more elements are not in direct contact with each other, but yet still cooperate, communicate, and/or interact with each other.

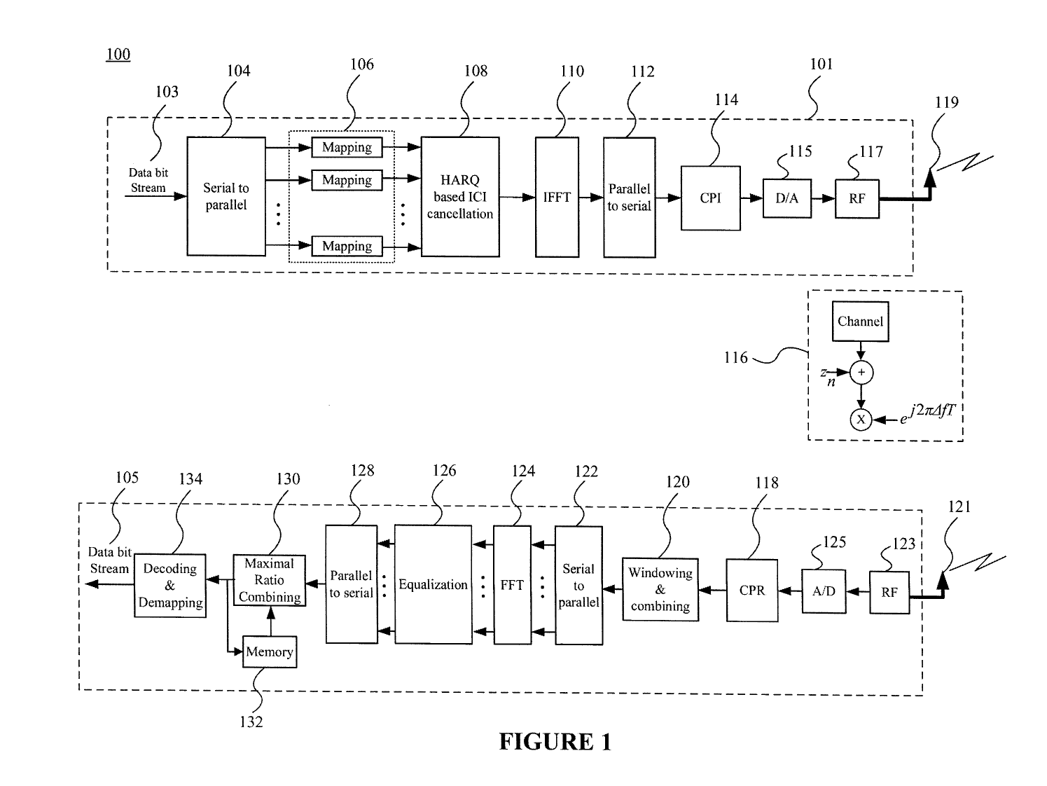

FIG. 1 illustrates a high-level functional block diagram of an OFDM system 100 consistent with some embodiments of the present invention. It should be understood that various functional units depicted in FIG. 1, can in practice, individually or in any combinations, be implemented in hardware, in software executed on one or more hardware components (such as one or more processors, one or more application specific integrated circuits (ASIC's) or other such components) or in any combination thereof.

System 100 includes a transmitter 101 and a receiver 102. Transmitter 101 may be part of a base station and receiver 102 may be part of an access point. Conversely, transmitter 101 may be part of an access terminal and receiver 102 may be part of a base station. A base station may be a fixed or mobile transceiver that communicates/exchanges data with one or more access points within a certain range. An access point may be a fixed or mobile communication device, such as a mobile telephone, a personal computer, a television receiver, a MP3 player, a personal digital assistant (PDA) or any other video, audio, or data device capable of radio communications.

Transmitter 101 includes a serial to parallel (S/P) unit 104 coupled to a mapping unit 106. S/P 104 is coupled to receive a serial bit stream 103 and configured to divide bit stream 103 into N parallel bit streams, where N is a number of orthogonal sub-carriers on which data is encoded for transmission in OFDM system 100. Mapping unit 106 receives the N parallel bit streams from S/P 104 and maps the N parallel bit streams to a set of complex valued data symbols (X₀, X₁, X₂, . . . , X_{N-1}) using a modulation constellation such as PSK, 16-QAM, 64-QAM or other such modulation schemes.

Transmitter 101 further includes an ICI cancellation unit 108 that is coupled to mapping unit 106. ICI cancellation unit 108 receives from mapping unit 106 the set of data symbols (X₀, X₁, X₂, . . . , X_{N-1}), and encodes each data symbol onto a particular sub-carrier using at least one of several coding schemes that mitigate the effects of ICI. The coding schemes used by ICI cancellation unit 108 are discussed below.

An inverse fast Fourier transform (IFFT) unit 110 is coupled to receive the set of data symbols encoded by ICI cancellation unit 108. IFFT 110 transforms the set of encoded data symbols from ICI cancellation unit 108 into an OFDM symbol comprising N independently modulated sub-carriers in the time domain. A parallel to serial (P/S) unit 112 coupled to IFFT 110 is used to convert the time domain sub-carriers into a serial format for framing. Transmitter 101 also includes a cyclic prefix insertion unit (CPI) 114 to insert a cyclic prefix (CP) between successive OFDM symbols in order to mitigate the effects of inter-symbol-interference (ISI).

A digital-to-analog (D/A) converter 115 is coupled to CPI 114. D/A converter 115 converts a group of OFDM symbols to an analog domain OFDM symbol stream. A radio frequency (RF) block 117 coupled to D/A converter 115 receives the OFDM symbol stream and generates an OFDM signal by modulating the N orthogonal sub-carriers of each OFDM symbol to a carrier frequency. The OFDM signal is transmitted to receiver 102 by RF 117 over a channel 116 using an antenna 119.

A discrete-time base band OFDM signal during one symbol interval before the insertion of the CP can be expressed as:

$${x}_{n} = \frac{1}{N} {\sum }_{m = 0}^{N - 1} {X}_{m} {e}^{j2π \frac{m}{N} n} , 0 \leq n \leq N - 1 \qquad ( 1 )$$

where n is an integer that represents a discrete-time index, and Xₘ is a data symbol modulated on an m-th sub-carrier. The OFDM signal after the insertion of the CP by CPI 114 can be expressed as

$${x}_{n} = \{ \begin{matrix}\frac{1}{N} {\sum }_{m = 0}^{N - 1} {X}_{m} {e}^{j2π \frac{m}{N} n} , & 0 \leq n \leq N - 1 \\ {x}_{N + n} , & - {N}_{g} \leq n \leq - 1\end{matrix} \qquad ( 2 )$$

where N_{g} is the duration of a guard interval.

Signal Xₙ is transmitted over channel 116 (such as a wireless channel) to receiver 102. Transmitted signal xₙ may be modified as it passes through channel 116, resulting in a modified signal yₙ. The modified signal yₙ can be expressed in the discrete-time domain as:

$${y}_{n} = {e}^{j2πΔ f \frac{n}{N}} \cdot h \cdot {x}_{n} + {z}_{n} , 0 \leq n \leq N - 1 \qquad ( 3 )$$

where Δf represents the normalized frequency offset, h represents complex channel fading and zₙ represents complex additive white Gaussian noise (AWGN).

Receiver 102 includes an RF block 123 which receives signal yₙ the time domain) through an antenna 121. RF 123 retrieves the OFDM symbol stream from the carrier frequency and provides the retrieved symbol stream to A/D 125. A/D 125 further converts the OFDM symbol stream into the digital domain.

Receiver 102 further includes a cyclic prefix removal unit (CPR) 118 which is coupled to remove the CP inserted by CPI 114. In some embodiments, receiver 102 includes a windowing and combining unit (WAC) 120 coupled as shown in FIG. 1. WAC 120 implements a window based time domain ICI cancellation method to further mitigate the effects of ICI.

Receiver 102 further includes a S/P unit 122 coupled with a fast Fourier transform (FFT) unit 124. S/P 122 converts each OFDM symbol in the symbol stream to a parallel format and FFT 124 generates N independently modulated sub-carriers for each OFDM symbol by taking a Fourier transform. The data symbol modulated on the m-th sub-carrier of an OFDM symbol can be expressed as follows:

$$\begin{matrix}\begin{matrix}{Y}_{m} = \frac{1}{N} {\sum }_{n = 0}^{N - 1} {y}_{n} {e}^{- j2π \frac{n}{N} m} \\ = \frac{1}{N} {\sum }_{n = 0}^{N - 1} ( {e}^{j2πΔ f \frac{n}{N}} \cdot h \cdot {x}_{n} + {z}_{n} ) {e}^{- j2π \frac{n}{N} m} \\ = \frac{1}{N} {\sum }_{n = 0}^{N - 1} \{ {e}^{j2πΔ f \frac{n}{N}} \cdot h \cdot ( {\sum }_{{m}^{′} = 0}^{N - 1} {X}_{{m}^{′}} {e}^{j2π \frac{n}{N} {m}^{′}} ) + {z}_{n} \} {e}^{- j2π \frac{n}{N} m} \\ = h \cdot {\sum }_{{m}^{′} = 0}^{N - 1} {X}_{{m}^{′}} \frac{1}{N} {\sum }_{n = 0}^{N - 1} {e}^{- j2π \frac{n}{N} ( m - {m}^{′} - Δ f )} + {Z}_{m} \\ = \underbrace{h \cdot {C}_{0} \cdot {X}_{m}}_{desired signal} + h \cdot \underbrace{( {\sum }_{{m}^{′} = 0 , {m}^{′} \neq m}^{N - 1} {C}_{m - {m}^{′}} \cdot {X}_{{m}^{′}} )}_{ICI terms} + {Z}_{m}\end{matrix} \\ where & ( 4 ) \\ {C}_{0} = \frac{1}{N} {\sum }_{n = 0}^{N - 1} {e}^{j2π \frac{n}{N} Δ f} & ( 5 ) \\ \begin{matrix}{C}_{m - {m}^{′}} = \frac{1}{N} {\sum }_{n = 0}^{N - 1} {e}^{- j2π \frac{n}{N} ( m - {m}^{′} - Δ f )} \\ = \frac{1}{N} \frac{sin π ( m - {m}^{′} - Δ f )}{sin π \frac{( m - {m}^{′} - Δ f )}{N}} \cdot {e}^{jπ \frac{( N - 1 ) ( m - {m}^{′} - Δ f )}{N}}\end{matrix} & ( 6 )\end{matrix}$$

Yₘ represents a received data symbol (demodulated symbol) corresponding to transmitted symbol Xₘ of a corresponding OFDM symbol. Equation (5) represents the ICI coefficient of a desired sub-carrier, for example the m-th sub-carrier, and equation (6) represents leakage coefficients induced by constant frequency offset. In a hypothetical ideal system, Δf=0, so that C₀=1 and the leakage coefficients C₁, C₂ . . . C_{N-1}=0, implying the absence of ICI.

The outputs of FFT 124 are coupled to an equalization unit 126 and a parallel to serial (P/S) unit 128 as shown in FIG. 1. In some embodiments, receiver 102 includes a maximum ratio combining unit (MRC) 130 coupled with a memory 132. A decoding and de-mapping (DD) unit 134 is coupled to receive the demodulated data symbols from MRC 130, and to decode the demodulated data symbols to obtain a decoded data symbol. For example, DD 134 decodes demodulated data symbol Yₘ to obtain decoded data symbol \tilde{X}ₘ, where decoded symbol \tilde{X}ₘ corresponds to transmitted data symbol Xₘ of a corresponding OFDM symbol. In a hypothetical ideal transmission, data symbol Xₘ=data symbol \tilde{X}ₘ.

In order to enhance the robustness of system 100 against ICI, while maintaining a high overall data rate, system 100 implements a hybrid automatic repeat-request (HARQ) based method for ICI cancellation. The HARQ based method involves transmitter 101 transmitting an original transmission of packet data and multiple retransmissions of packet data corresponding to the original packet data. Each retransmitted packet can include a part or all of the transmitted data symbols of the original data packet. For convenience, the following description assumes that a data packet includes a part or all of the data symbols corresponding to a set of data symbols (X₀, X₁, X₂, . . . , X_{N-1}). However, there may be any number of data symbols corresponding to any number of sets of data symbols that can be included in a given data packet. Therefore, the present disclosure is not limited in the number of data symbols or the number of sets of data symbols that may be included and supported by an OFDM system that is consistent with the present invention.

Receiver 102 receives, demodulates, and stores the original transmission and all corresponding retransmissions in memory 132. In one embodiment, receiver 102 implements a symbol level chase combining method to decode the transmitted data symbols. In the chase combining method, MRC 130 combines the original transmission with all of the corresponding retransmissions, and DD 134 decodes the combination to obtain the transmitted data symbols. DD 134 further de-maps the decoded symbols to obtain an output data bit stream 105.

In some embodiments, receiver 102 sends an acknowledgement (ACK) to transmitter 101 upon receiving and correctly decoding a transmission (data packet), and receiver 102 can further send a non-acknowledgement (NACK) if one or more errors occur in decoding the transmitted packet.

Transmitter 101 sends a retransmission of the original packet data in response to the NACK, and a new transmission that can include new original packet data in response to the ACK. In some embodiments, if transmitter 101 does not receive the ACK within a defined time duration, a retransmission is sent by transmitter 101.

Tables 1, 2 and 3 illustrate various coding schemes implemented by ICI cancellation unit 108 consistent with some embodiments of the present invention.

In one embodiment, ICI cancellation unit 108 implements an ICI cancel coding scheme. In the ICI cancel coding scheme, ICI unit 108 encodes data symbols (X₀, X₁, X₂, . . . , X_{N/2-1}) onto sub-carriers (f₀, f₁, f₂, . . . , f_{N-1}) as shown in Table 1.

TABLE 1
ICI cancel coding

| f₀ | f₁ | f₂ | f₃ | . . . | f_{N-2} | f_{N-1} |
|---|---|---|---|---|---|---|
| X₀ | −X₀ | X₁ | −X₁ | . . . | ${X}_{\frac{N}{2} - 1}$ | $- {X}_{\frac{N}{2} - 1}$ |

As can be seen in Equations (4), (5), and (6), since the severity of the effects of ICI of a desired sub-carrier, for example the m-th sub-carrier, depends primarily on the difference in the leakage coefficients of the neighboring sub-carriers (C_{m-m′}), the implementation of the above coding scheme helps reduce the effects of ICI induced by a frequency offset. For example, based on the above coding scheme, the demodulated data symbol on the 0^{th} sub-carrier (Y₀) can be expressed as:

Y₀=(C₀−C₁)X₀+(C₂−C₃)X₁+ . . . +(C_{N-2}−C_{N-1})X_{N/2-1} (7)

The decoded data symbol (\tilde{X}₀) corresponding to transmitted data symbol X₀ is decoded as:

$$\begin{matrix}{\tilde{X}}_{0} = {Y}_{0} - {Y}_{1} \\ = ( 2 {C}_{0} - {C}_{1} - {C}_{N - 1} ) {X}_{0} + ( 2 {C}_{2} - {C}_{3} - {C}_{1} ) {X}_{1} + … + \\ ( 2 {C}_{N - 2} - {C}_{N - 1} - {C}_{N - 3} ) {X}_{\frac{N}{2} - 1}\end{matrix} \qquad ( 8 )$$

In another embodiment, ICI cancellation unit 108 implements an antipodal coding scheme as shown in Table 2.

TABLE 2
Antipodal cancel coding

| | f₀ | f₁ | f₂ | f₃ | . . . | f_{N-2} | f_{N-1} |
|---|---|---|---|---|---|---|---|
| 1^{st} | X₀ | X₁ | X₂ | X₃ | . . . | X_{N-2} | X_{N-1} |
| packet | | | | | | | |
| 2^{nd} | X₀ | −X₁ | X₂ | −X₃ | . . . | X_{N-2} | −X_{N-1} |
| packet | | | | | | | |

This antipodal coding scheme entails an antipodal cancel coding method by which multiple transmissions (packets) containing the same data symbols are sent from transmitter 101 to receiver 102. In an original transmission (first packet data), ICI cancellation unit 108 encodes each data symbol onto a particular sub-carrier. In a second packet (retransmission), ICI cancellation unit 108 implements the antipodal cancel coding scheme as shown in Table 2. For convenience, Table 2 depicts the antipodal coding scheme as being implemented in the second packet (retransmission). However, ICI cancellation unit 108 can implement the antipodal cancel coding scheme in any transmission (original transmission and/or retransmission) included in system 100. Therefore, the present disclosure is not limited in the implementation of the antipodal cancel coding scheme in any particular transmission that may be included and supported by an OFDM system that is consistent with the present invention.

By encoding the transmitted symbols as depicted in Table 2, the demodulated data symbols, for example the demodulated symbol on the 0^{th} sub-carrier of the 1^{st} transmission Y₀⁽¹⁾ and demodulated symbol on the 0^{th} sub-carrier of the 2^{nd} transmission (retransmission) Y₀⁽²⁾, can be expressed as follows:

Y₀⁽¹⁾=h₀⁽¹⁾·C₀X₀+h₁⁽¹⁾·C₁X₁+h_{N-1}⁽¹⁾·C_{N-1}X_{N-1} (9)

Y₀⁽²⁾=h₀⁽²⁾·C₀X₀−h₁⁽²⁾·C₁X₁−h_{N-1}⁽²⁾·C_{N-1}X_{N-1} (10)

Equation (9) represents the demodulated symbol of the first transmission and equation (10) represents the demodulated symbol of the second transmission (retransmission). For convenience, only the neighboring ICI coefficients of the desired sub-carrier have been depicted in equations (9) and (10). However, there may be any number of ICI coefficients included in system 100. Therefore, the present disclosure is not limited in the number of coefficients that may be included and supported by an OFDM system that is consistent with the present invention.

The demodulated symbols of the original transmission and corresponding retransmission are stored in memory 132. MRC 130 combines the first and second transmissions and DD 134 decodes that combination to obtain the transmitted data symbols. For example, decoded symbol (\tilde{X}₀) corresponding to transmitted symbol X₀ can be decoded by DD 134 as:

$$\begin{matrix}{\tilde{X}}_{0} = {h}_{0}^{( 1 ) *} {Y}_{0}^{( 1 )} + {h}_{0}^{( 2 ) *} {Y}_{0}^{( 2 )} \\ = {C}_{0} \cdot ( {\vert {h}_{0}^{( 1 )} \vert}^{2} + {\vert {h}_{0}^{( 2 )} \vert}^{2} ) \cdot {X}_{0} + {C}_{1} \cdot ( {h}_{0}^{( 1 ) *} \cdot {h}_{1}^{( 1 )} - {h}_{0}^{( 2 ) *} \cdot {h}_{1}^{( 2 )} ) \cdot \\ {X}_{2} + {C}_{2} \cdot ( {h}_{0}^{( 1 ) *} \cdot {h}_{N - 1}^{( 1 )} - {h}_{0}^{( 2 ) *} \cdot {h}_{N - 1}^{( 2 )} ) \cdot {X}_{N - 1}\end{matrix} \qquad ( 11 )$$

Where (*) denotes the complex conjugate of the corresponding term.
Similarly, decoded symbol (\tilde{X}₁) corresponding to transmitted symbol X₀ is decoded as:

\tilde{X}₁=h₁⁽¹⁾*Y₁⁽¹⁾+h₁⁽²⁾*Y₁⁽²⁾ (12)

DD 134 further de-maps the decoded data symbols to obtain output bit stream 105.

In another embodiment, ICI cancellation unit 108 implements a conjugate cancel coding scheme as shown in Table 3.

TABLE 3
Conjugate cancel coding

| | f₀ | f₁ | f₂ | f₃ | . . . | f_{N-2} | f_{N-1} |
|---|---|---|---|---|---|---|---|
| 1^{st} | X₀ | X₁* | X₂ | X₃* | . . . | X_{N-2} | X_{N-1}* |
| packet | | | | | | | |
| 2^{nd} | −X₁ | X₀* | −X₃ | X₂* | . . . | −X_{N-1} | X_{N-2}* |
| packet | | | | | | | |

In the conjugate cancel coding method, the data symbols during the first and second transmissions, i.e., original transmission and retransmission, respectively, are encoded as shown in Table 3. For convenience, Table 3 depicts the conjugate cancel coding scheme as being implemented in the original transmission (first packet) and retransmission (second packet). However, ICI cancellation unit 108 can implement the conjugate cancel coding scheme in any transmission (original transmission and/or retransmission) included in system 100. Therefore, the present disclosure is not limited in the implementation of the conjugate cancel coding scheme in any particular transmission that may be included and supported by an OFDM system that is consistent with the present invention.

The demodulated data symbols of the first and second transmission can be expressed in a similar manner as discussed with respect to equations (9) and (10). Output bit stream 105 is obtained in a manner similar to that discussed for the antipodal coding scheme above.

In another embodiment, ICI cancellation unit 108 implements a coding scheme as shown in Table 4.

TABLE 4
HARQ Based ICI Cancellation coding Scheme

| | f₀ | f₁ | f₂ | f₃ | . . . | f_{N-2} | f_{N-1} |
|---|---|---|---|---|---|---|---|
| Original Transmitted Packet | X₀ | X₁ | X₂ | X₃ | . . . | X_{N-2} | X_{N-1} |
| 1^{st} Retransmitted Packet | X₀ | −X₀ | X₁ | −X₁ | . . . | ${X}_{\frac{N}{2} - 1}$ | $- {X}_{\frac{N}{2} - 1}$ |
| 2^{nd} Retransmitted Packet | ${X}_{\frac{N}{2}}$ | $- {X}_{\frac{N}{2}}$ | ${X}_{\frac{N}{2} + 1}$ | $- {X}_{\frac{N}{2} + 1}$ | . . . | X_{N-1} | −X_{N-1} |

To further mitigate the effects of ICI, the data symbols of the original transmission can be divided into groups. The data symbols of each group can then be encoded onto their respective sub-carriers and can be transmitted consecutively in separate retransmissions. As seen in Table 4, the data symbols from the original transmission (original transmitted packet) are divided into two groups, and the two groups are transmitted consecutively in the retransmissions (first and second retransmitted packet, respectively). For example, data symbol X₀ and X_{N/2} are encoded onto the same sub-carrier and transmitted consecutively in the first retransmitted packet and the second retransmitted packet, respectively. The demodulated data symbols of the first retransmitted packet and the second retransmitted packet can be expressed in a similar manner as discussed for equation (8). Output bit stream 105 is obtained in a manner similar to that discussed for the antipodal coding scheme above.

In another embodiment, to compensate for transmission rate loss that occurs due to the implementation of various ICI canceling schemes, transmitter 101 can include multiple antennas for data transmission and receiver 102 can include multiple antennas for data reception. Each set of modulated data symbols to be transmitted is split into groups and each group of modulated data symbols is encoded by ICI cancellation unit 108 using a coding scheme such as, for example, depicted in any one of Tables 1-3. In this embodiment, transmitter 101 transmits each group of modulated data symbols to receiver 102 using a separate antenna for each group.

In some embodiments, ICI cancellation unit 108 can implement different coding schemes on the data symbols to be transmitted over different antennas. Table 5 depicts the multi-antenna coding scheme implemented by ICI cancellation unit 108. For convenience, two antennas designated Antenna 1 and Antenna 2 are shown in Table 5. However, there may be any number of antennas included in system 100. Therefore, the present disclosure is not limited in the number of antennas that may be included and supported by an OFDM system that is consistent with the present invention.

TABLE 5
HARQ Based ICI Cancellation coding Scheme
with Two Transmit Antennas

| | f₀ | f₁ | f₂ | f₃ | . . . | f_{N-2} | f_{N-1} |
|---|---|---|---|---|---|---|---|
| Original Transmitted Packet | X₀ | X₁ | X₂ | X₃ | . . . | X_{N-2} | X_{N-1} |
| Retransmitted Packet on Antenna 1 | X₀ | −X₀ | X₁ | −X₁ | . . . | ${X}_{\frac{N}{2} - 1}$ | $- {X}_{\frac{N}{2} - 1}$ |
| Retransmitted Packet Antenna 2 | ${X}_{\frac{N}{2}}$ | $- {X}_{\frac{N}{2}}$ | ${X}_{\frac{N}{2} + 1}$ | $- {X}_{\frac{N}{2} + 1}$ | . . . | X_{N-1} | −X_{N-1} |

With reference to Table 5, the data symbols of the original transmission can be divided into two groups. The data symbols of each group can be encoded onto their respective sub-carriers and can be transmitted simultaneously via the separate antennas, i.e., antenna 1 and antenna 2. For example, data symbol X₀ and X_{N/2} are encoded simultaneously onto the same sub-carrier and can be retransmitted via antenna 1 and antenna 2, respectively. The demodulated data symbols of the retransmissions for each antenna can be expressed in a similar manner as discussed for equation (8). Output bit stream 105 is obtained in a manner similar to that discussed for the antipodal coding scheme above.

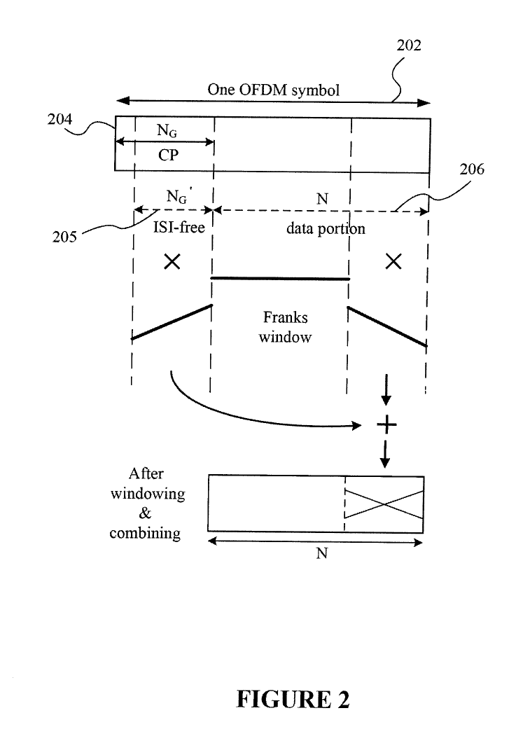

In another embodiment, to further improve the robustness of the data transmission against the effects of ICI, WAC 120 implements a time domain ICI cancellation method. FIG. 2 illustrates the time domain ICI cancellation method implemented by WAC 120. As shown in FIG. 2, WAC 120 receives an OFDM symbol 202 in the time domain. Symbol 202 can include a CP portion 204 and a data portion 206. WAC 120 can apply a Franks window W(n) on symbol 202 and WAC 120 further combines an ISI-free region 205 of CP portion 204 with the corresponding part of data portion 206 (as shown in FIG. 2) to obtain a new OFDM symbol. The analysis of the Franks window of WAC 120 can be expressed as

$$W ( n ) = \{ \begin{matrix}1 , & 0 \leq \vert n \vert < \frac{N ( 1 - α )}{2} \\ 1 - \frac{\vert n \vert}{N} , & \frac{N ( 1 - α )}{2} \leq \vert n \vert < \frac{N ( 1 + α )}{2} \\ 0 , & otherwise\end{matrix} \qquad ( 13 )$$

where

$$α ≡ \frac{{N}_{G}}{N}$$

represents ISI-free region 205 of CP portion 204.

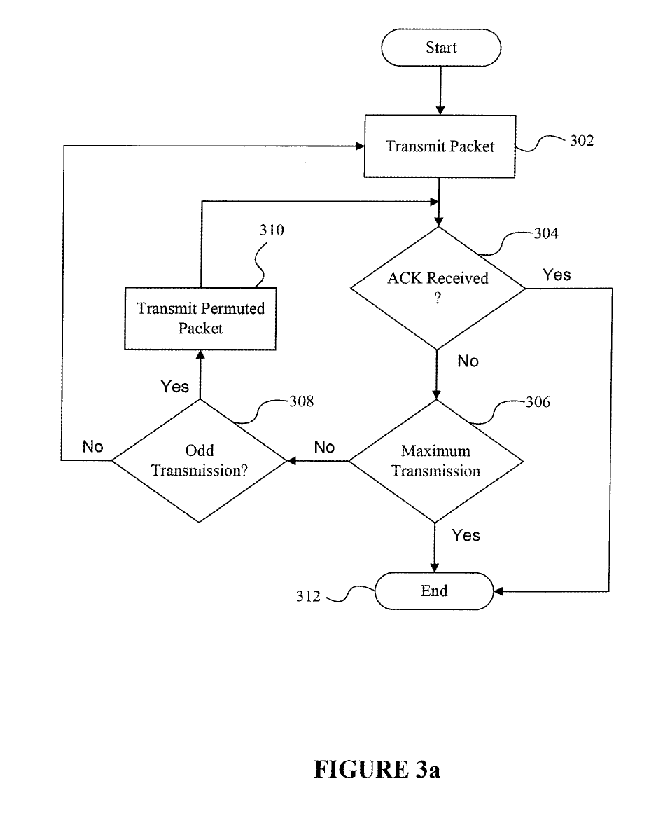

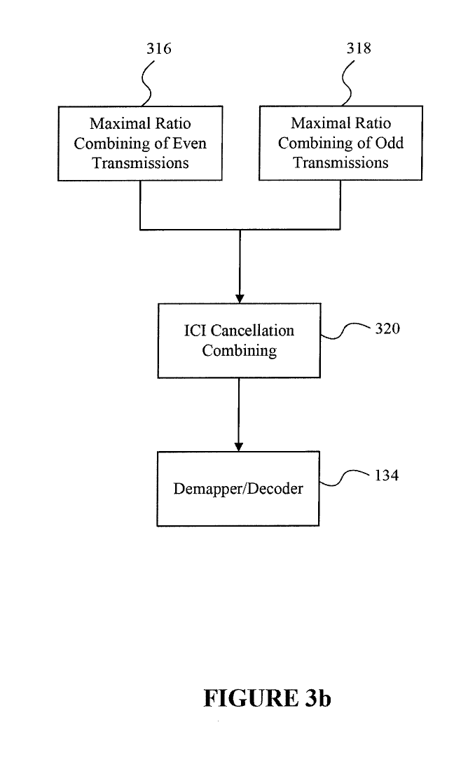

FIGS. 3a and 3b illustrate flow diagrams of HARQ based methods implemented by system 100 consistent with some embodiments of the present invention. As illustrated in FIG. 3a, transmitter 101 transmits an original transmission of packet data to receiver 102 (302). Receiver 102 decodes the original transmission and sends an ACK to transmitter 101 (304). If the ACK (Acknowledgement) is not received or NACK (Non-acknowledgement) is received (304—No), then at 306 transmitter 101 checks for a transmission number of a current transmission. Each transmission (original and corresponding retransmissions) is assigned a transmission number. For example the original transmission can be assigned number 0, the first retransmission can be assigned number 1, the second retransmission can be assigned number 2, etc. In addition, system 100 can be configured (for example by software instructions) to include a maximum number of retransmissions corresponding to an original transmission.

If a maximum transmission number has not been exceeded (306—No), and if a current transmission number is odd (1, 3, 5, etc.) (308—Yes), in step 310 transmitter 101 transmits an encoded data packet to receiver 102. The encoded data packet is computed based on one of the ICI cancellation coding schemes depicted in Tables 1-5. If the current transmission is an even transmission (0, 2, 4, etc.) (308—No), the transmission process is reset and transmitter 101 transmits a new original transmission. If, on the other hand, transmitter 101 receives the ACK (304—Yes) or if the maximum transmission number is exceeded (306—Yes), at 312 the current transmission is ended and transmitter 101 transmits a new original transmission and/or restarts the current transmission.

FIG. 3b is a flow diagram illustrating the chase combining method performed at receiver 102. As mentioned above, the original transmission and corresponding retransmissions are stored at receiver 102 in memory 132. With reference to FIG. 3b, at 316, 318, and 320, MRC 130 combines the even transmissions, the odd transmissions, and the combined even and odd transmissions, respectively. DD 134 receives and decodes the combination to obtain the original packet data.

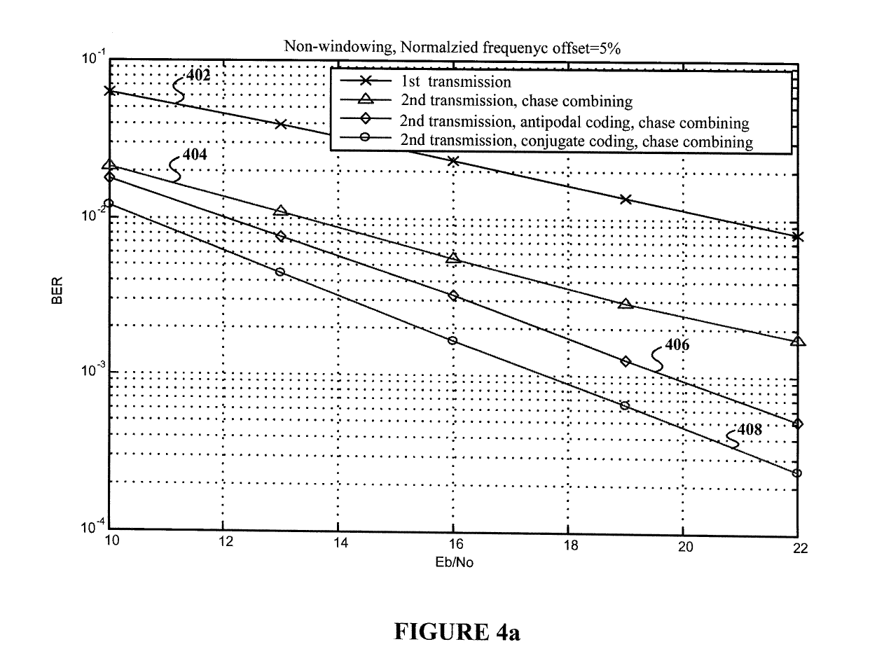

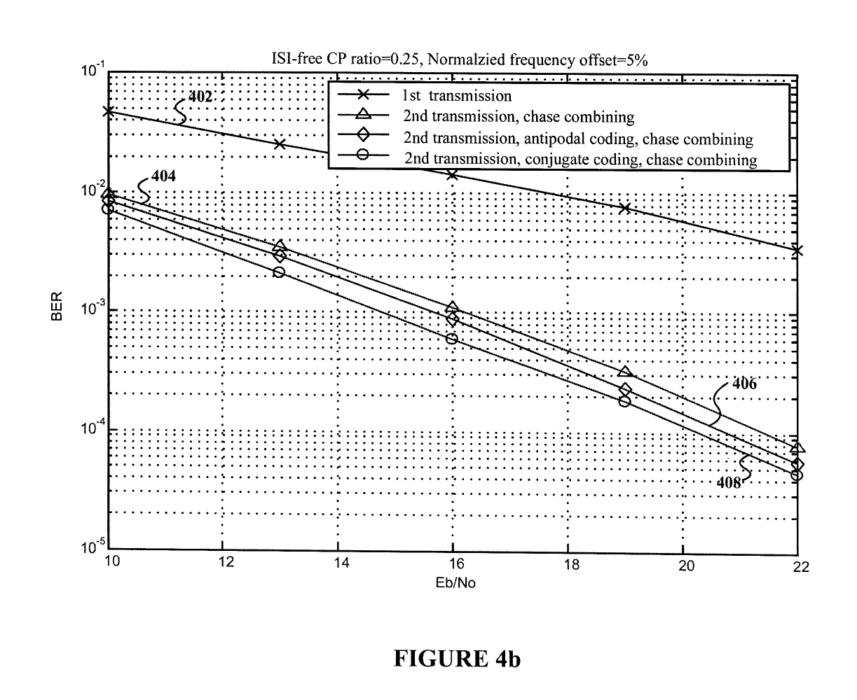

FIGS. 4a and 4b are graphs illustrating plots of signal-to-noise (SNR) (depicted on the x-axis as E_{b}/Nₒ, where E_{b}/Nₒ is the ratio of the energy per bit to noise power spectral density) vs. bit error rate (BER) performance of system 100. The data for these plots were obtained by simulating operation of system 100 implementing the various coding schemes consistent with the present invention. The simulation of system 100 was performed using 16-QAM modulation, 256 sub carriers, a CP ratio of 0.25, a normalized frequency offset of 5%. FIG. 4a illustrates the performance of system 100 without the implementation of a window by WAC 120 and FIG. 4b illustrates the performance of system 100 with WAC 120 implementing a window with ISI-free region 205 having a ratio of 0.25.

In FIG. 4a, plot 402, illustrates the performance of system 100 for an original transmission with no coding scheme implemented. Plots 404, 406, and 408 illustrate the performance of system 100 when the ICI cancel coding depicted in Table 1, the antipodal cancel coding depicted in Table 2, and the conjugate cancel coding depicted in Table 3 are implemented, respectively. The implementation of the various coding schemes (plots 404, 406, and 408) improved the performance of system 100 in comparison with plot 402 (no coding scheme) by reducing the BER for a given SNR level. As can be seen in FIG. 4a, the conjugate coding scheme (plot 408) outperformed the other coding schemes by providing the smallest BER for a given SNR level

Based on a comparison of the plots in FIG. 4a and the corresponding plots in FIG. 4b, the addition of the window based time domain ICI cancellation further improved the overall performance of system 100. As can be seen in FIG. 4b, the addition of the window based time domain ICI cancellation further reduced the BER for a given SNR level in each of the implemented coding schemes.

Other embodiments will be apparent to those skilled in the art from consideration of the specification and practice disclosed herein. It is intended that the specification and examples be considered as exemplary only, with a true scope and spirit of the invention being indicated by the following claims.

What is claimed is:

1. A method for transmitting data in an OFDM communication system, comprising:
transmitting over a channel an original data packet that includes original data, the original data packet including at least one modulated data symbol encoded onto at least one sub-carrier using a first coding scheme; and
transmitting a retransmitted data packet corresponding to the original data packet in response to a non-acknowledgement (NACK), the retransmitted data packet including a copy of the original data packet wherein the at least one modulated data symbol is encoded onto the at least one sub-carrier using a second coding scheme.

2. The method of claim 1 including a plurality of modulated data symbols encoded onto a respective plurality of subcarriers, the method further comprising:
dividing the plurality of modulated data symbols into at least two groups wherein each of the plurality of modulated data symbols in each of the at least two groups is encoded onto its respective sub-carrier using the first coding scheme;
transmitting each of the at least two groups via at least one antenna; and
transmitting a retransmitted group via the at least one antenna, in response to the NACK, the retransmitted group including each of the plurality of modulated data symbols of one of the at least two groups encoded onto its respective sub-carrier using the second coding scheme.

3. The method of claim 1, including a plurality of modulated data symbols encoded onto a respective plurality of subcarriers, the method further comprising:
encoding each of the plurality of modulated data symbols onto its respective sub-carrier using the first coding scheme.

4. The method of claim 1, including a plurality of modulated data symbols encoded onto a respective plurality of subcarriers, the method further comprising:
encoding each of the plurality of modulated data symbols onto its respective sub-carrier using the second coding scheme.

5. The method of claim 1, including a plurality of modulated data symbols encoded onto a respective plurality of subcarriers, the method further including:
providing the first coding scheme and the second coding scheme as the same coding scheme.

6. The method of claim 1, including a plurality of modulated data symbols encoded onto a respective plurality of subcarriers, the method further including providing the first coding scheme or the second coding scheme as an antipodal cancel coding scheme.

7. The method of claim 1, including a plurality of modulated data symbols encoded onto a respective plurality of subcarriers, the method further including providing the first coding scheme or the second coding scheme as a conjugate cancel coding scheme.

8. The method of claim 1, including a plurality of modulated data symbols encoded onto a respective plurality of subcarriers, the method further including providing the first coding scheme or the second coding scheme as an ICI cancellation coding scheme.

9. A method for receiving data in an OFDM communication system, comprising:
receiving over a channel an original data packet that includes original data, the original data packet including at least one modulated data symbol encoded onto at least one sub-carrier;
sending an Acknowledgement (ACK) if no error is detected in the original data packet or sending a non-acknowledgement (NACK) if an error is detected in the original data packet, and storing the original data packet;
receiving in response to the NACK a retransmitted data packet corresponding to the original data packet, and storing the retransmitted data packet; and
combining the original data packet and the retransmitted data packet, and decoding the combination to obtain the original data.

10. The method of claim 9 including a plurality of modulated data symbols encoded onto a respective plurality of sub-carriers, the method further comprising:
receiving over the channel at least one group of the plurality of modulated data symbols, and storing each received group;
sending the ACK if no error is detected in each group or sending the NACK if an error is detected in at least one group;
receiving in response to the NACK a retransmitted group corresponding to the at least one group and storing the retransmitted group; and
combining the at least one group and the corresponding retransmitted group and decoding the combination to obtain the original data.

11. The method of claim 9 including a plurality of modulated data symbols encoded onto a respective plurality of sub-carriers, the method further comprising:
receiving a time domain OFDM symbol corresponding to each of the plurality of modulated data symbols encoded onto the respective plurality of sub-carriers, the time domain OFDM symbol including a cyclic prefix (CP) portion and a data portion;
applying a window to the time domain OFDM symbol and determining an inter-symbol interference (ISI) free portion of the CP; and
combining the ISI-free portion of the CP with the data portion of the time domain OFDM symbol.

12. A transmitter in an OFDM communication system, comprising:
an inter-carrier interference (ICI) canceling unit coupled to receive at least one modulated data symbol, and in response to a NACK, utilizing at least one processing device to encode the at least one modulated data symbol onto at least one sub-carrier by implementing a coding scheme.

13. The transmitter of claim 12 including the ICI canceling unit encoding a plurality of modulated data symbols onto a respective plurality of sub-carriers, wherein the ICI canceling unit is configured to encode each of the plurality of modulated data symbols onto the respective plurality of sub-carriers by implementing the coding scheme.

14. The transmitter of claim 12 including the ICI canceling unit encoding a plurality of modulated data symbols onto a respective plurality of sub-carriers, wherein the ICI canceling unit is configured to implement the coding scheme as an antipodal cancel coding scheme.

15. The transmitter of claim 12 including the ICI canceling unit encoding a plurality of modulated data symbols onto a respective plurality of sub-carriers, wherein the ICI canceling unit is configured to implement the coding scheme as a conjugate cancel coding scheme.

16. The transmitter of claim 12 including the ICI canceling unit encoding a plurality of modulated data symbols onto a respective plurality of sub-carriers, wherein the ICI canceling unit is configured to implement the coding scheme as an ICI cancel coding scheme.

17. A receiver in an OFDM communication system, comprising:
a windowing and combining (WAC) unit coupled to receive a plurality of time domain OFDM symbols corresponding to a plurality of modulated data symbols encoded onto a respective plurality of sub-carriers, each of the time domain OFDM symbols including a cyclic prefix (CP) and a data portion;
a memory;
a maximum ratio combining (MRC) unit coupled to receive a plurality of transmissions of packet data, the plurality of transmissions of packet data including the plurality of modulated data symbols encoded onto the respective plurality of sub-carriers, if the plurality of transmissions of packet data correspond to an original data packet, the MRC unit configured to store each of the plurality of modulated data symbols in the memory and to combine the received plurality of transmissions of packet data; and
a decoder and de-mapping (DD) unit DD coupled to receive the combination of the plurality of transmissions of packet data and to decode the combination.

18. The receiver of claim 17 wherein the WAC is configured to implement a window on each of the plurality of time domain OFDM symbols to obtain an inter-symbol interference (ISI)-free portion of the CP and to combine the ISI-free portion of the CP with the data portion of the time domain OFDM symbol.

19. The receiver of claim 17 wherein the MRC is configured to receive a plurality of transmissions of packet data as a sequence of even and odd transmissions of packet data, the MRC further configured to combine each of the even transmissions of packet data and each of the odd transmissions of packet data and to combine the combined even transmissions of packet data and the combined odd transmissions of packet data.

20. The receiver of claim 17 wherein the DD is configured to decode the combination of the combined even transmissions and the combined odd transmissions.
